(19) United States
(12) Patent Application Publication
(10) Pub. No.: US 2019/0244259 A1
(43) Pub. Date: Aug. 8, 2019

(54) METHOD AND SYSTEM FOR GENERATING AN ADAPTIVE ACTION CAMPAIGN INVOLVING A PLURALITY OF USERS

(71) Applicant: INTOUCH INSIGHT LTD., Ottawa (CA)

(72) Inventor: Ravi PUVANACHANDRAN, Ottawa (CA)

(73) Assignee: INTOUCH INSIGHT LTD., Ottawa (CA)

(21) Appl. No.: 16/230,019

(22) Filed: Dec. 21, 2018

Related U.S. Application Data
(60) Provisional application No. 62/626,735, filed on Feb. 6, 2018.

(51) Int. Cl. G06Q 30/02; G06Q 10/06

(52) U.S. Cl. CPC G06Q 30/0281; G06Q 10/063114

(57) ABSTRACT

A method and system are disclosed for generating an adaptive action campaign involving a plurality of users, the method comprising generating an action campaign, the action campaign comprising at least one task to be performed by at least one corresponding user, each user located in a corresponding location; transmitting an indication of each of the at least one task to be performed to a user processing device of a corresponding user of the at least one corresponding user; obtaining data related to the at least one task to be performed from the user processing device of each of the corresponding users; obtaining key performance indicator data related to each location; generating an action campaign dashboard using the obtained data related to the at least one task to be performed and the obtained key performance indicator data, the action campaign dashboard providing an indication of a completion of each task to be performed and the key performance indicator data and providing the generated action campaign dashboard.

### CROSS-REFERENCE TO RELATED APPLICATION

The present patent application claims the benefit of U.S. Provisional Patent Application No. 62/626,735, filed on Feb. 6, 2018.

### FIELD

This invention relates to the field of customer experience management. More precisely, the invention pertains to a method and system for generating an adaptive action campaign involving a plurality of users.

### BACKGROUND

The field of the invention is Customer Experience Management (CEM) software, which is also referred to as Customer Feedback Management (CFM) software.

Customer Experience Management is an organized or central way for companies to take customer complaints, ideas, suggestions or requests. The purpose is to use customer feedback to expand and modify services/products in a way that is likely to appeal to customers. Customer Experience Management softwares help to collect, organize and analyze customer feedback, enabling companies to better respond to market changes and meet customer demands.

While existing Customer Experience Management software solutions are good at gathering customer feedback, they do not really offer a solution to help organizations operationalize customer experience actions. Many organizations use manual processes to define specific activities, or tasks, that certain individuals must do to deliver targeted customer experiences.

Manual processes can be in the form of documents that are sent via email or printout to multiple roles within the organization. Unfortunately, these emails and printouts can be misplaced or lost. It is also difficult to validate if employees are following the intended tasks or making any business improvements because of those tasks.

Furthermore, it is time-consuming and difficult to analyze if certain tasks worked to improved specified business outcomes, which is a limitation. As a matter of fact, analysts must spend a lot of manual effort to determine the impact of different playbooks on different parts of the organization.

Rolling out tasks manually across an organization is cumbersome and has many flaws, i.e., not integrated, lack of transparency and latency.

Customer Experience Management vendors include Qualitrics (www.qualtrics.com/), Medallia (www.medallia.com) and Questback (www.questback.com/). The leaders in this space have case management features. For instance, a case is typically assigned to an individual who can then reassign and set due dates on the case. This works for solving a specific problem, e.g., a light bulb is broken, but this does not address the manual task problem where multiple roles in the organization must perform different tasks at different frequencies to ensure a customer experience journey point is enhanced, such as for instance improve call wait times by 50% and delivery times by 1 day.

Mobile forms products such as prontoforms (https://www.prontoforms.com/) and gocanvas (https://www.gocanvas.com/) are available, but those platforms are not integrated with Customer Experience Management. They do not coordinate multiple roles and multiple forms/checklists in a cohesive fashion which is also a limitation. Another limitation is that they cannot track performance of the tasks against defined business metrics. Another limitation is that they do not optimize tasks, roles and frequency based on their correlation to important business metrics.

There is therefore a need for a method and a system that will overcome at least one of the above-identified drawbacks.

### BRIEF SUMMARY

According to a broad aspect, there is disclosed a method for generating an adaptive action campaign involving a plurality of users, the method comprising use of a processing unit for generating an action campaign, the action campaign comprising at least one task to be performed by at least one corresponding user, each user located in a corresponding location; transmitting an indication of each of the at least one task to be performed to a user processing device of a corresponding user of the at least one corresponding user; obtaining data related to the at least one task to be performed from the user processing device of each of the corresponding users; obtaining key performance indicator data related to each location; generating an action campaign dashboard using the obtained data related to the at least one task to be performed and the obtained key performance indicator data, the action campaign dashboard providing an indication of a completion of each task to be performed and the key performance indicator data and providing the generated action campaign dashboard.

According to one embodiment, the action campaign comprises a plurality of tasks, wherein the generating of the action campaign comprises grouping more than one task to form a checklist of tasks.

According to one embodiment, the generating of the action campaign further comprises associating a temporal indication to each task of the checklist of tasks formed.

According to one embodiment, the generating of the action campaign further comprises performing a checklist of tasks assignment comprising assigning at least one user to the checklist of tasks formed; wherein the transmitting of each of the at least one task to be performed comprises sending to each user processing device of each user of each of the at least one user assigned to the checklist of tasks an indication of the more than one given corresponding task.

According to one embodiment, the method further comprises amending the checklist of tasks assignment.

According to one embodiment, the generating of the action campaign comprises applying at least one rule on the at least one task to be performed.

According to one embodiment, the at least one rule is derived from data obtained from at least one previous action campaign performed.

According to one embodiment, the generating of the action campaign comprises generating a recommendation.

According to one embodiment, the at least one task to be performed comprises an action to execute and a temporal indication associated with the at least one task.

According to one embodiment, the temporal indication comprises a duration allocated for completing the at least one task.

According to one embodiment, the temporal indication comprises a frequency for performing the at least one task.

According to one embodiment, the generating of the action campaign comprises associating at least one key performance indicator (KPI) with the action campaign, wherein the at least one key performance indicator associated is affected by the action campaign.

According to one embodiment, the transmitting of the indication of each of the at least one task to be performed comprises executing an application on a corresponding user processing device and downloading the indication of each of the at least one task to be performed in the application.

According to one embodiment, the transmitting of the indication of each of the at least one task to be performed comprises a given user accessing a webserver using a corresponding user processing device.

According to one embodiment, the data related to the task to be completed comprises an indication of a completion of the task.

According to one embodiment, the data related to the task to be completed comprises at least one of a geocoded picture and a note related to the task to be completed.

According to one embodiment, the obtaining of the data related to the task to be performed from the user processing device of each of the corresponding users is performed in response to a request.

According to one embodiment, the key performance indicator data related to each location comprises refers to data dependent on the at least one task to be performed.

According to one embodiment, the key performance indicator data related to each location is obtained from a remote processing unit operatively connected with the processing unit.

According to one embodiment, the key performance indicator data related to each location is obtained from a memory unit operatively connected with the processing unit.

According to one embodiment, the providing of the generated action campaign dashboard comprises at least one of displaying an indication of an evolution of the action campaign and displaying at least one recommendation to a user.

According to one embodiment, the providing of the generated action campaign dashboard comprises displaying a task completion rate and an average score for at least one corresponding user.

According to one embodiment, the displaying of the task completion rate and the average score is performed for a plurality of users, wherein each of the plurality of users is from a given role.

According to one embodiment, the action campaign dashboard is provided to at least one of a user interacting with the processing unit and a remote processing device operatively connected with the processing unit.

According to a broad aspect, there is disclosed a processing device comprising a central processing unit; a display device; a communication port; a memory unit comprising an application for generating an adaptive action campaign involving a plurality of users, the application comprising instructions for generating an action campaign, the action campaign comprising at least one task to be performed by at least one corresponding user, each user located in a corresponding location; instructions for transmitting an indication of each of the at least one task to be performed to a user processing device of a corresponding user of the at least one corresponding user; instructions for obtaining data related to the at least one task to be performed from the user processing device of each of the corresponding users; instructions for obtaining key performance indicator data related to each location; instructions for generating an action campaign dashboard using the obtained data related to the at least one task to be performed and the obtained key performance indicator data, the action campaign dashboard providing an indication of a completion of each task to be performed and the key performance indicator data; and instructions for providing the generated action campaign dashboard.

According to a broad aspect, there is disclosed a non-transitory computer readable storage medium for storing computer-executable instructions which, when executed, cause a processing device to perform a method for generating an adaptive action campaign involving a plurality of users, the method comprising generating an action campaign, the action campaign comprising at least one task to be performed by at least one corresponding user, each user located in a corresponding location; transmitting an indication of each of the at least one task to be performed to a user processing device of a corresponding user of the at least one corresponding user; obtaining data related to the at least one task to be performed from the user processing device of each of the corresponding users; obtaining key performance indicator data related to each location; generating an action campaign dashboard using the obtained data related to the at least one task to be performed and the obtained key performance indicator data, the action campaign dashboard providing an indication of a completion of each task to be performed and the key performance indicator data and providing the generated action campaign dashboard.

It will be appreciated that the method disclosed herein enables the coordination of tasks, roles and frequencies within a customer experience management platform.

The method disclosed herein also enables performance tracking of customer experience tasks/activities, i.e., action campaigns, on specified business metrics, which is a great advantage.

The method disclosed herein provides a solution to a technical problem of generating, coordinating and managing an action campaign efficiently. Furthermore, it will be appreciated that the processing device is mandatory for implementing the method disclosed herein. In fact, the use of the processing device enables, for instance, to optimize tasks, roles and frequency based on its correlation to important business metrics or key performance indicators (KPIs), such as for instance and in one embodiment “Net promoter score (NPS),” “retention rate” and “store sales.”

In fact, being able to obtain key performance indicator data related to each location and use such key performance indicator data when generating the action campaign dashboard and during the action campaign per se enable to efficiently manage the action campaign. It also enables to adapt the action campaign accordingly and is therefore of great advantage. The action campaign becomes flexible since it may be readily amended based on feedback provided by the key performance indicator data for instance. It will be therefore appreciated that this greatly improves the operating of a system for managing tasks as well as the efficiency of the action campaign per se which are of great advantage.

The method disclosed herein may further generate recommendations based on observations made during at least one of existing action campaigns and past action campaigns, which is of great advantage.

Another advantage provided by the method disclosed herein is that it improves response time to customer feedback by amending accordingly an action campaign.

Another advantage provided by the method disclosed herein is that it enables organizations to objectively and readily track business outcomes to action campaigns.

Another advantage provided by the method disclosed herein is that it may also provide an indication of optimizations or recommendations which may be required to improve business outcomes.

### BRIEF DESCRIPTION OF THE DRAWINGS

In order that the invention may be readily understood, embodiments of the invention are illustrated by way of example in the accompanying drawings.

FIG. 1 is a diagram which shows an embodiment of a system for generating an adaptive action campaign involving a plurality of users.

FIG. 2 is a diagram which shows an embodiment of a processing device used in a system for generating an adaptive action campaign involving a plurality of users.

FIG. 3 is a flowchart which shows an embodiment of a method for generating an adaptive action campaign involving a plurality of users.

FIG. 4 is a screenshot which shows a graphics user interface of an action campaign dashboard illustrating a plurality of action campaigns.

FIG. 5 is a screenshot which shows a graphics user interface of an action campaign dashboard illustrating metrics associated with the action campaign.

FIG. 6 is a screenshot which shows a graphics user interface of an action campaign dashboard illustrating certain data associated with the action campaign.

FIG. 7 is a screenshot which shows a graphics user interface of an action campaign dashboard illustrating how a checklist assignment may be added or amended in accordance with an embodiment.

FIG. 8 is a screenshot which shows a graphics user interface of an action campaign dashboard illustrating results generated by an action campaign.

FIG. 9 is a screenshot which shows a graphics user interface of an action campaign dashboard illustrating recommendations generated for a given action campaign following an analysis.

FIG. 10 is a block diagram which illustrates how recommendations and rules may be generated in accordance with an embodiment.

FIG. 11 is a table which illustrates at least one recommendation which can be obtained from the normalized data.

FIG. 12 is a table which illustrates at least one rule which can be obtained from the normalized data.

Further details of the invention and its advantages will be apparent from the detailed description included below.

### DETAILED DESCRIPTION OF THE INVENTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain.

The term “i.e.” and like terms mean “that is,” and thus limit the terms or phrases they explain.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

With all this in mind, the present invention is directed to a method and a system for generating an adaptive action campaign involving a plurality of users.

It will be appreciated that the method disclosed herein is of great advantage over the prior art for various reasons as further explained below. The system may be used in a company for generating and managing an action campaign.

In one embodiment, the company operates across various business entities e.g. locations and brands. Each business entity is characterized by at least one corresponding key performance indicator.

It will be appreciated by the skilled addressee that the method disclosed herein may be implemented using various types of processing devices. As a matter of fact, the processing device may be selected from a group consisting of laptop computers, tablet computers, desktop computers, smartphones, servers and the like.

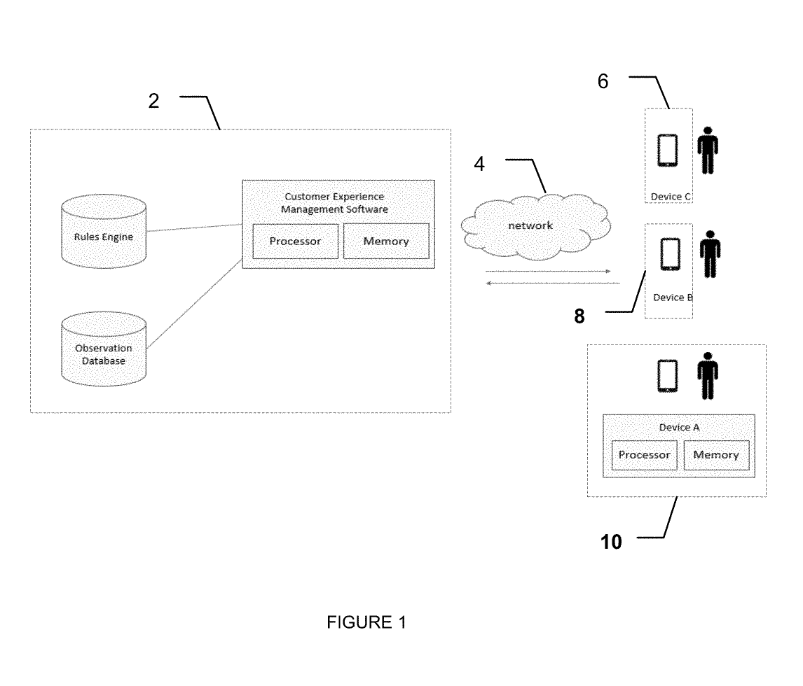

Still referring to FIG. 1, it will be appreciated that the system comprises a processing device 2.

The system further comprises a plurality of user processing devices. The plurality of user processing devices comprises for instance user processing device 6, user processing device 8 and user processing device 10. The skilled addressee will appreciate that any number of user processing device may be used.

It will be appreciated that each user processing device may be selected from a group consisting of laptop computers, tablet computers, desktop computers, smartphones, servers and the like.

It will be appreciated that each user processing device is operated by a corresponding user.

It will be further appreciated that in one embodiment each user is located at a corresponding given location of the company.

It will be also be appreciated that each user has a given role in the company. For instance and in one embodiment, the given role may be selected from a group consisting of «upper management», «frontline staff», «trainers» and «managers». The skilled addressee will appreciate that roles may vary from one company to another.

It will be appreciated that each of the plurality of user processing devices is operatively connected to the processing device 2 via a data network 4.

The data network 4 may be selected from a group consisting of a local area networks (LAN), metropolitan area networks (MAN) and wide area networks (WAN). In one embodiment, the data network 4 comprises the Internet.

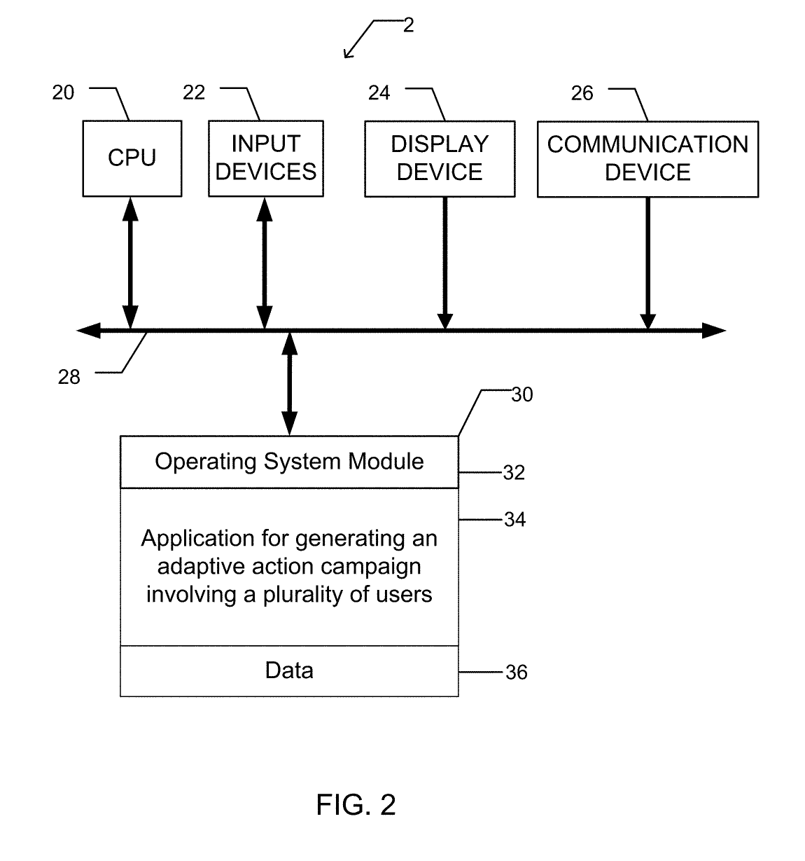

Now referring to FIG. 2, there is shown an embodiment of a processing device 2 which may be used for generating an adaptive action campaign involving a plurality of users.

In this embodiment, the processing device 2 comprises a central processing unit (CPU) 20, also referred to as a microprocessor, a display device 24, input devices 22, a communication device 26, a data bus 28 and a memory unit 30.

The central processing unit 20 is used for processing computer instructions. The skilled addressee will appreciate that various embodiments of the central processing unit 20 may be provided.

In one embodiment, the central processing unit 82 is a Core i5 Intel™ processor running at 2.5 GHz and manufactured by Intel™.

The display device 24 is used for displaying data to a user of the processing device 2. The skilled addressee will appreciate that various types of display devices may be used.

In one embodiment, the display device 24 comprises a standard liquid-crystal display (LCD) monitor.

The communication device 26 is used for sharing data with the processing device 2. The communication device 26 may also be used for enabling a connection with another processing device, not shown.

The communication device 26 may comprise, for instance, a universal serial bus (USB) port for connecting a keyboard and a mouse to the processing device 2.

The communication device 26 may further comprise a data network communication port, such as an IEEE 802.3 (Ethernet) port, for enabling a connection of the processing device 2 with a user processing device as explained above.

The skilled addressee will appreciate that various alternative embodiments of the communication device 26 may be provided.

The memory unit 30 is used for storing computer executable instructions.

It will be appreciated that the memory unit 30 comprises in one embodiment an operating system module 32.

It will be appreciated by the skilled addressee that the operating system module 32 may be of various types.

In an embodiment, the operating system module 32 is iOS (Version 11.2.5) manufactured by Apple™.

It will be appreciated that the memory unit 30 further comprises an application for generating an adaptive action campaign involving a plurality of users 34.

The memory unit 30 further comprises data used by the application for generating an adaptive action campaign involving a plurality of users 34.

Each of the processing unit 20, the display device 24, the input devices 22, the communication device 26 and the memory unit 30 is interconnected via the data bus 28.

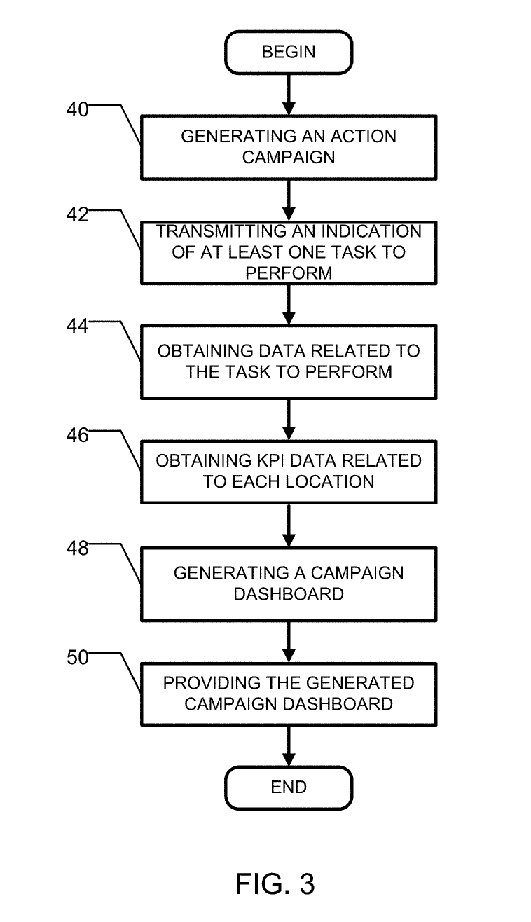

Now referring to FIG. 3, there is shown an embodiment of a method for generating an adaptive action campaign involving a plurality of users.

According to processing step 40, an action campaign is generated.

It will be appreciated that an action campaign may also be referred to as a set of customer experience tasks or activities.

It will be further appreciated that the action campaign comprises at least one task to be performed by at least one corresponding user. It will be appreciated that at least one task may be referred to as a checklist or a checklist of tasks.

Accordingly, it will be appreciated that in accordance with an embodiment, the generating of the action campaign comprises grouping more than one task to form a checklist.

Alternatively the task may be performed by another user under the supervision of the user.

It will be appreciated that each user of the at least one user is located at at least one corresponding location of the company, as explained above.

It will be further appreciated by the skilled addressee that the task to be performed may be defined by an action to execute with a temporal indication associated thereto. The temporal indication may be, for instance, a duration for performing the task. Such duration may be defined for instance using a start date and an end date. The temporal indication may alternatively be a frequency for performing the task. It will be therefore appreciated that the generating of the action campaign comprises associating a temporal indication to each task of the checklist of tasks formed.

It will be appreciated that the action campaign may also be associated with at least one key performance indicator (KPI). The at least one key performance indicator may be defined by a user. Alternatively, at least one key performance indicator associated with the action campaign is automatically associated with the action campaign. It will be appreciated that the at least one key performance indicator associated with the action campaign may be affected by the action campaign.

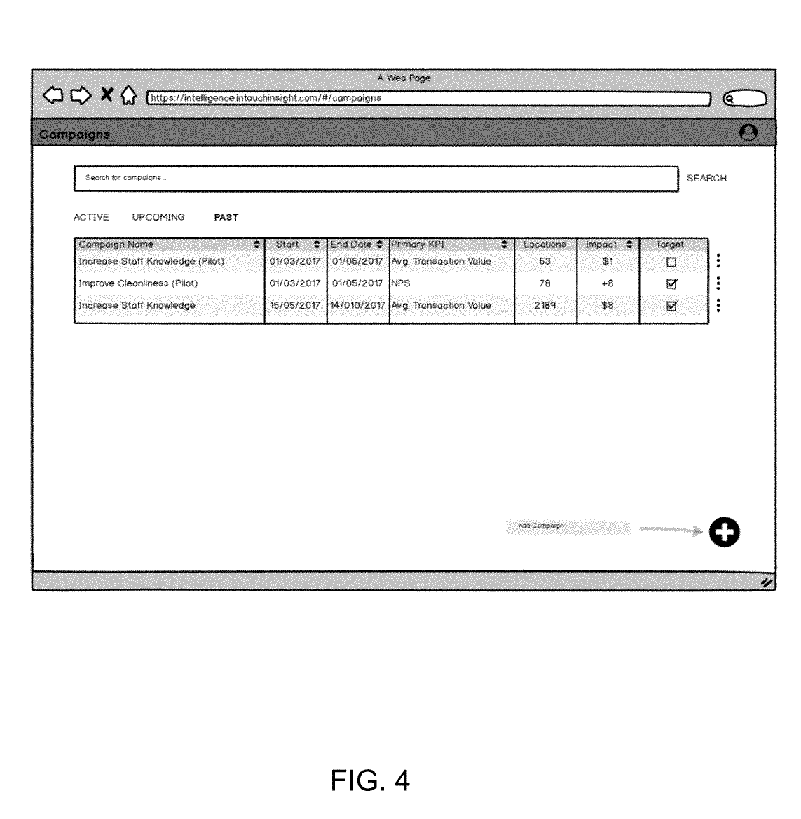

Now referring to FIG. 4, there is shown a graphics user interface of an action campaign dashboard illustrating three action campaigns concurrently running. It will be appreciated that active as well as upcoming and past action campaigns may be also be displayed in the action campaign dashboard. It will be appreciated that a user may therefore be capable of readily and quickly monitoring a progress against selected metrics, as further explained below.

More precisely, FIG. 4 shows a corresponding start date and a corresponding end date for each action campaign.

It will also be appreciated that each action campaign has also at least one corresponding key performance indicator associated therewith.

It will also be appreciated that each action campaign has at least one location associated therewith.

It will be appreciated that the action campaign may be generated according to various embodiments. In fact and in one embodiment, the action campaign is generated using the processing device 2.

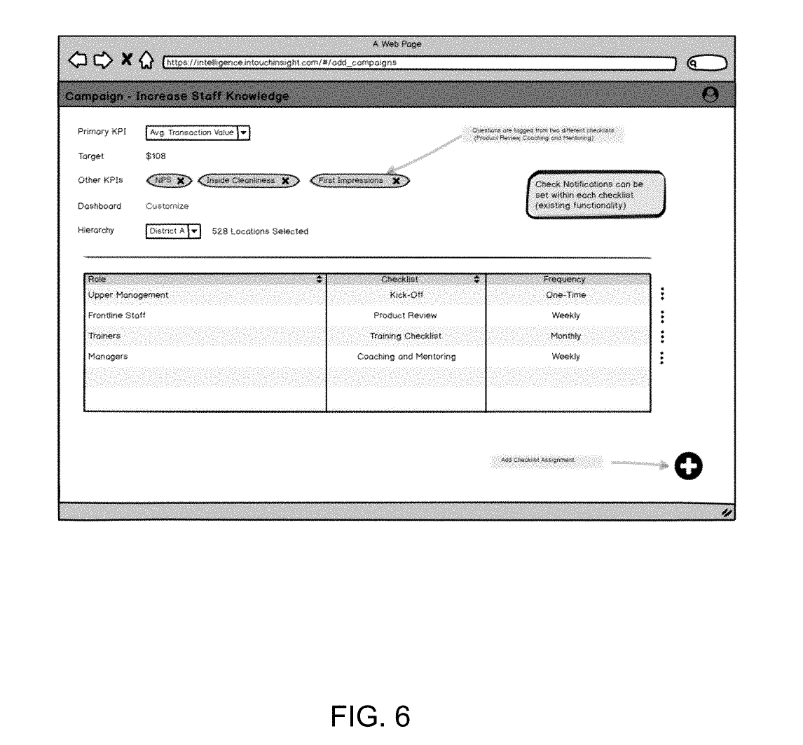

Now referring to FIG. 6, there is shown a graphics user interface of an action campaign dashboard illustrating certain data associated with the action campaign. More precisely, this graphics user interface illustrates how at least one business metrics, i.e., key performance indicator, may be selected, edited or deleted. As shown in FIG. 6, a main key performance indicator, i.e., “Average Transaction Value,” is associated with the action campaign. Three other key performance indicators, i.e., “NPS,” “Inside cleanliness” and “first impressions,” are also associated with this action campaign. It will be appreciated that the action campaign disclosed in FIG. 6 comprises four different checklists, i.e., “Kick-off,” “Product review,” “Training checklist,” “Coaching and mentoring,” associated to respectively four different roles of the company, i.e., “Upper management,” “Frontline staff,” “Trainers,” Managers.”

As mentioned above, it will be appreciated that a checklist can be referred to as a set of tasks to perform.

It will also be appreciated that to each given checklist is associated with a temporal indication, which is a frequency in the embodiment shown in FIG. 6.

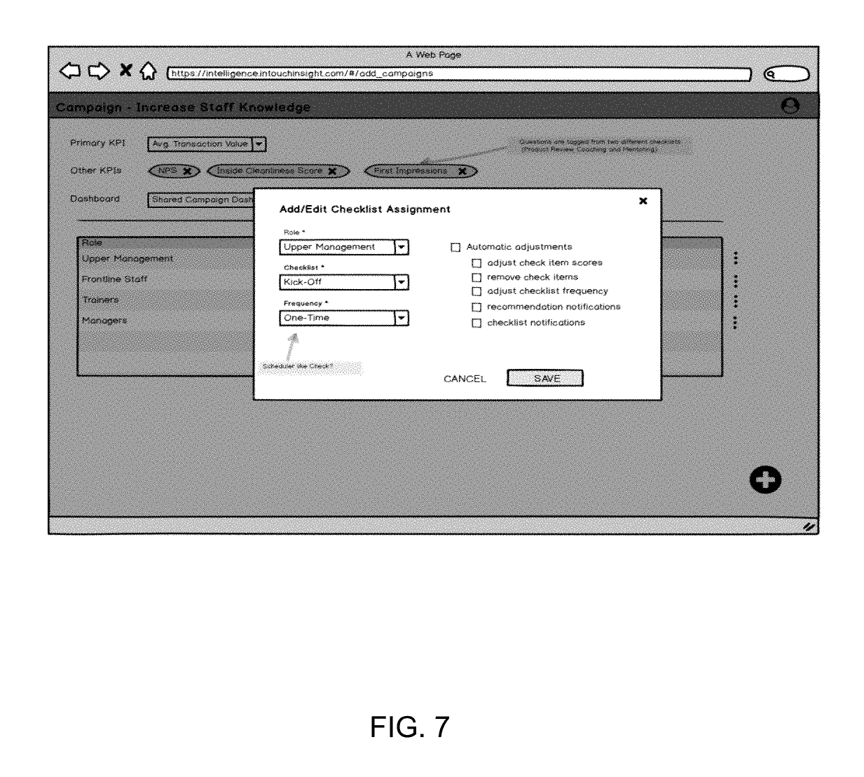

It will be appreciated that a checklist may be amended. Now referring to FIG. 7, there is shown a graphics user interface of an action campaign dashboard illustrating a menu showing how a checklist assignment may be added or edited.

It will be appreciated that, using the menu shown in FIG. 7, a selected frequency as well as a selected role may be assigned to any selected checklist.

It will be appreciated by the skilled addressee that the generating of the action campaign may comprise applying at least one rule to, for instance, various roles, locations, or device types (e.g., mobile device and desktop). It will be further appreciated that the at least one rule may be derived from data obtained from at least one previous action campaign performed such as for instance observations, such as completed tasks and its associated metadata, and on experimentations during a campaign. For instance, if there exist sufficient observations from one or more campaigns that determine that the “frontline staff” role in Florida completes their tasks at a higher rate and see better business outcomes if they get 2 reminders, for instance 1 day before and same day, for each task list, a rule may be created and may be applied to active and/or upcoming campaigns. For instance, if the “managers” role in Canada that uses desktops complies more if they receive notifications of how they compared with other managers (e.g., leaderboard), then another rule may be created and applied to active/upcoming campaigns. And so on (adjust check item scores) and so on (remove check items—randomize list/quota).

It will be appreciated that this processing step of generating at least one of a recommendation and a rule is optional.

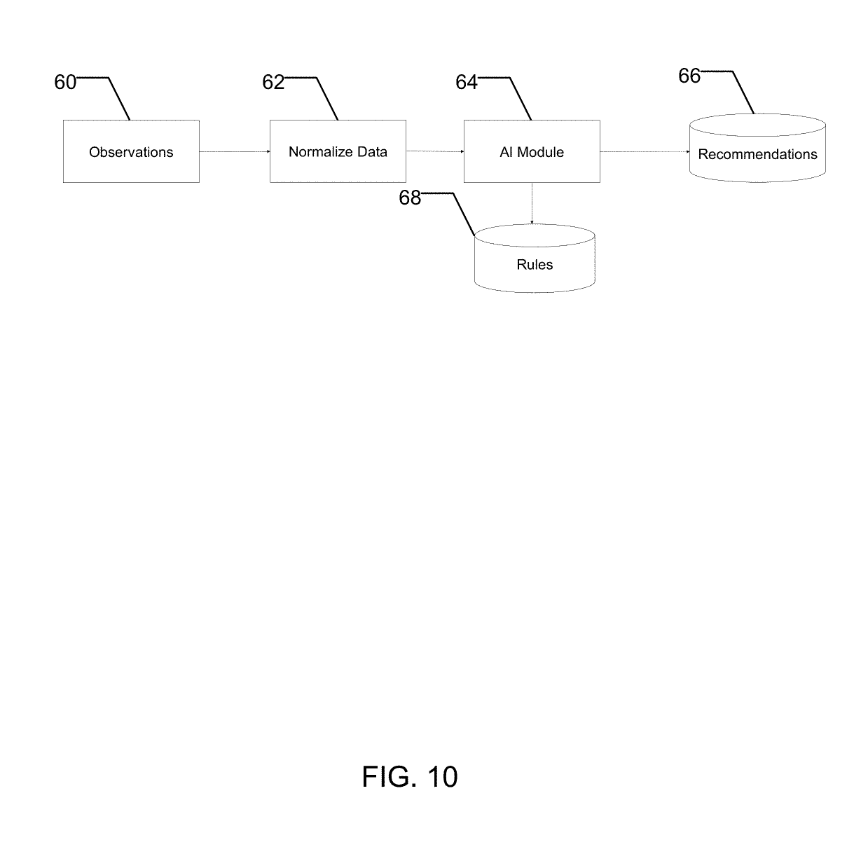

Now referring to FIG. 10, there is shown a block diagram which shows how a recommendation and a rule may be generated. It will be appreciated that observations 60 may be obtained from various sources. For instance, the observations may comprise data associated with a task completed in a given campaign. The observations may further comprise data associated with a key performance indicator, etc. It will be appreciated that a processing step of normalizing the observation data is performed. This processing step is referred to as normalize data 62 in FIG. 10. The purpose of the normalizing of the data is to be able to integrate the various observation data together. For instance, data related to a key performance indicator may be provided on a different time scale than data related to a task. In such case, the normalizing comprises providing the data on a common time scale.

Still referring to FIG. 10, it will be appreciated that an analyzing module, an example of which is the Al module 64, is used for analysing the normalized data. It will be appreciated that the purpose of the analyzing module is to determine at least one recommendation and at least one rule. A recommendation may be defined as something that should be done in a campaign to maximize a given output while a rule may be defined as a preference for an individual to maximize a given output.

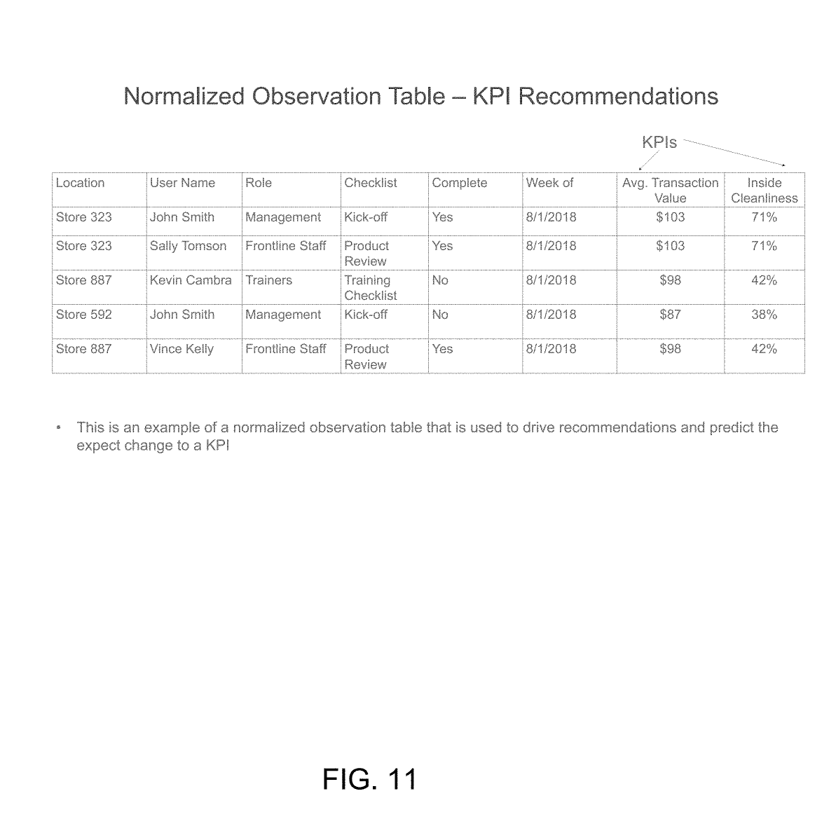

Now referring to FIG. 11, there is shown an example which shows an example of a recommendation. In this embodiment, a first recommendation may be that “management” role must be involved with the “Kick-off” checklist since it can be seen that this has an impact on the key performance indicators “Av. Transaction Value” and “Inside Cleanliness”. Another recommendation is that the “Product review” checklist for the role “Frontline staff” does not have an impact on “Inside Cleanliness.”

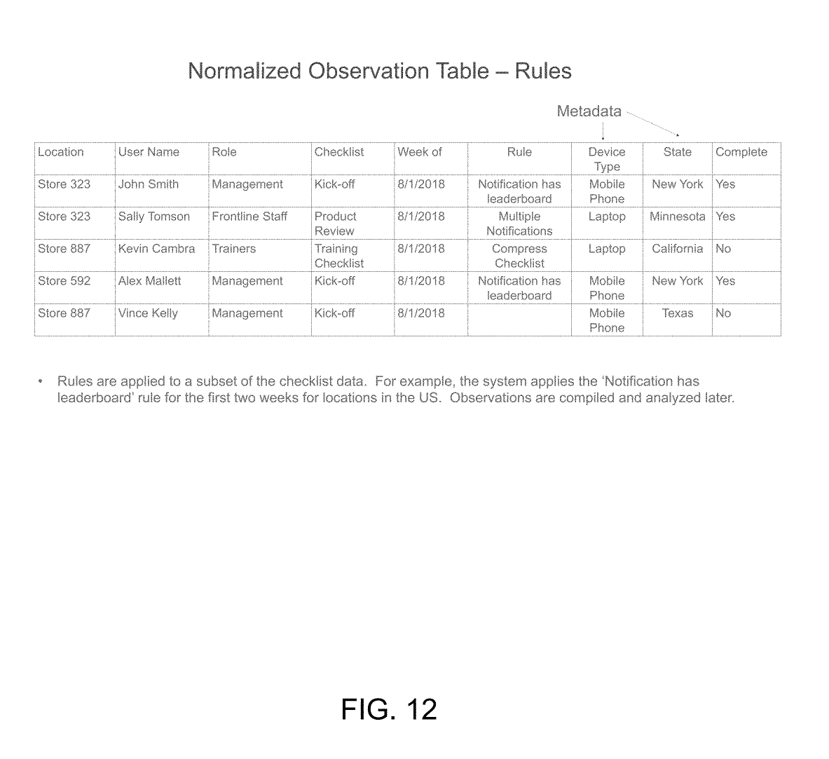

Now referring to FIG. 12, there is shown an example which shows an example of a rule which may be obtained. More precisely, in this embodiment a rule obtained is that there is a correlation between a completion of a task and a notification with a leaderboard. It will be appreciated that a notification is sent to a user either to remind the user to complete a task or when the task is completed. A rule generated is therefore to integrate a leaderboard to any notification sent to a “Management” user in order to optimize the chance to have the user complete the task. It will be appreciated that the at least one rule obtained may be applied for experimentation purposes (on a small subset of the checklist/task assignments) or it may be applied for a full campaign. Alternatively, the at least one rule may be applied to maximize a task completion rate or a key performance indicator based on a predictive (Al) model.

Now referring back to FIG. 3 and according to processing step 42, an indication of each of the at least one task to be performed is transmitted to a user processing device of a corresponding user of the at least one corresponding user.

In fact and as mentioned above, each user to which at least one task to be performed is transmitted is provided with a corresponding user processing device.

The corresponding user processing device is selected from a group consisting of smartphones, tablets, desktop computer, laptops, etc. In one embodiment, the corresponding user processing device is a smartphone carried by the corresponding user.

It will be further appreciated that the indication of at least one task to be performed may be transmitted according to various embodiments. In one embodiment, the indication of at least one task to be performed is obtained by each user by accessing a webserver hosted by the processing device 2. In another alternative embodiment, the indication of at least one task to be performed is obtained by each user by executing an application installed on the corresponding user processing device. The executing of the application installed on the corresponding user processing device causes the application to download the indication of at least one task to be performed. The skilled addressee will appreciate that various alternative embodiments may be provided for transmitting the at least one task to be performed to a user processing device.

According to processing step 44, data related to the task to be performed is obtained from the user processing device of each of the corresponding users.

It will be appreciated that the data related to the task to be performed may comprise for instance an indication as to whether the at least one task has been completed or not, i.e., an indication of a completion of the at least one task.

In another embodiment, the data related to the task to be performed comprises geo-coded pictures, for verification purposes, notes and follow-up tasks. It will be appreciated that follow-up tasks are additional tasks that were found while performing the assigned task. These can be completed after the assigned task is finished.

Moreover, it will be appreciated that the data related to the task to be performed may be obtained from the user processing device of each of the corresponding users according to various embodiments.

In one embodiment, the data related to the task to be performed is obtained from the user processing device upon request from the processing device 2. This may happen for instance when the user clicks “submit” when all the tasks are completed.

According to processing step 46, key performance indicator data related to each location is obtained.

It will be appreciated by the skilled addressee that this processing step may be performed concurrently with respect to the other processing steps. For instance, a customer survey is active at the same time and produces location/brand specific key performance indicator data. Also, for instance, stores sales may be captured from another system concurrently. It will be appreciated that the key performance indicator data refers to data that may be influenced by the at least one task to be performed.

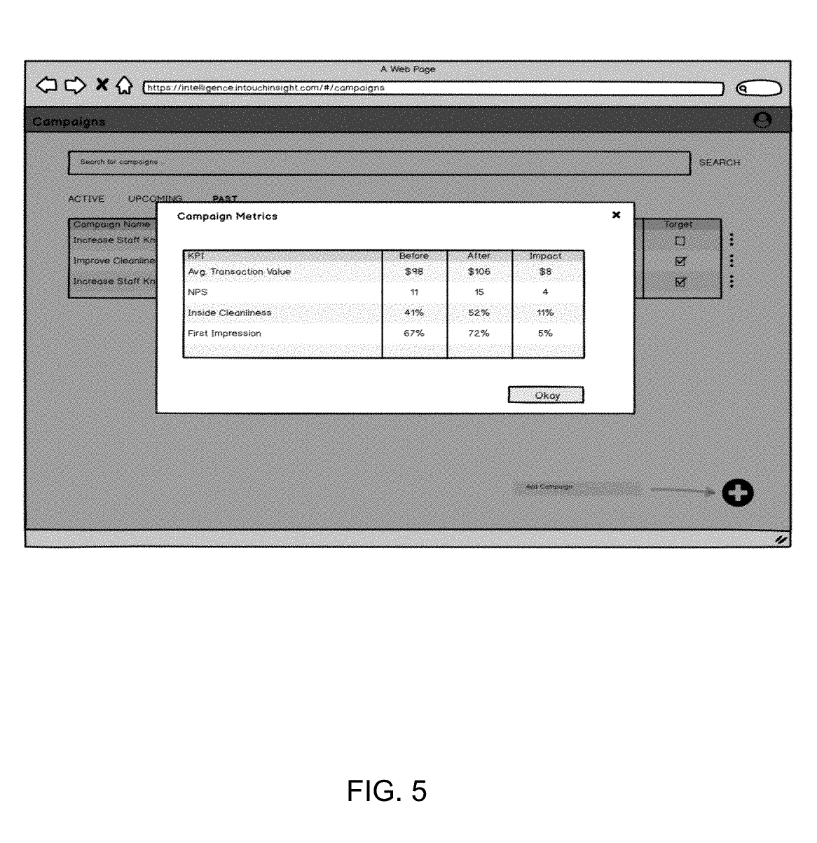

For instance, in one embodiment shown in FIG. 5, the key performance indicator data may comprise “Average transaction value,” “Net promoter score (NPS),” “Inside cleanliness” and “first impression.” The skilled addressee will appreciate that various alternative embodiments may be provided for the key performance indicator depending on the task to be performed.

It will be further appreciated that the key performance indicator data related to each location may be obtained according to various embodiments.

In one embodiment, the key performance indicator data related to each location is obtained from a remote processing unit, not shown, operatively connected to the processing device 2. In such case, the key performance indicator data are downloaded via a data network for instance.

In another embodiment, the key performance indicator data related to each location is obtained from the memory unit 30 of the processing device 2.

In another alternative embodiment, the key performance indicator data related to each location is obtained from other data collection methods, e.g., customer satisfaction survey, integration with financial or point-of-sale systems.

According to processing step 48, an action campaign dashboard is generated.

The action campaign dashboard may provide for instance an indication of a completion of each task to be performed and the corresponding key performance indicator data.

In one embodiment, the action campaign dashboard is generated using the processing device 2.

Now referring to FIG. 4, there is shown a screenshot which shows a graphics user interface of a generated action campaign dashboard illustrating a plurality of action campaigns.

It will be appreciated that the generated action campaign dashboard may be provided according to various embodiments.

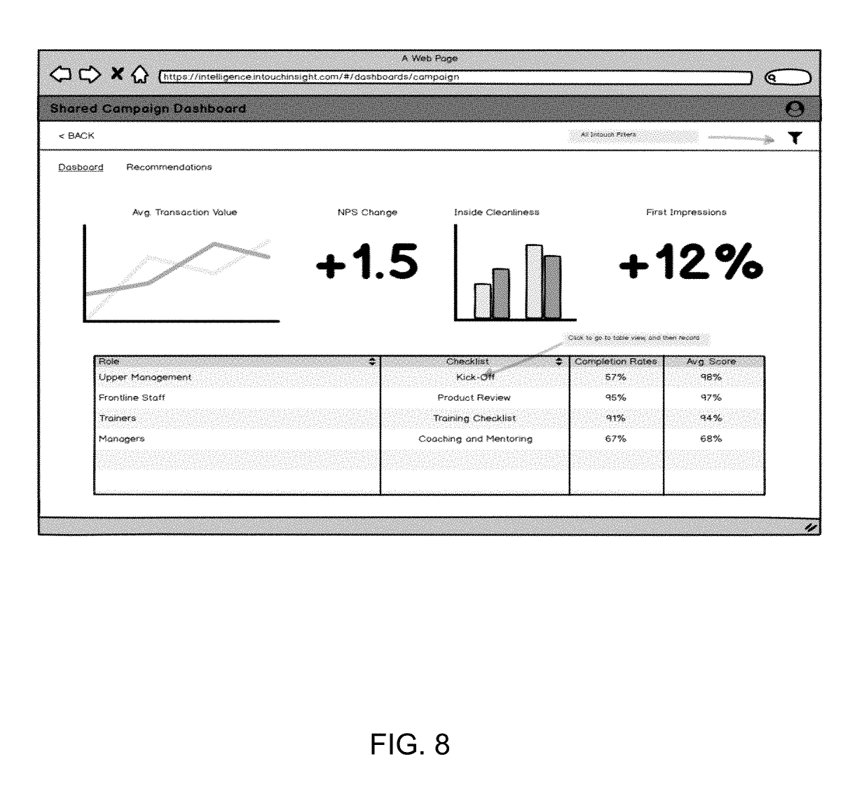

For instance and as shown in FIG. 8, the action campaign dashboard may display an indication of the evolution of the key performance indicators associated with the action campaign. In this figure, for instance, the indication of the evolution is provided using either graphs (bar chart for the key performance indicator “Inside cleanliness” or a line graph for the key performance indicator “Average transaction value”) or a corresponding number (in absolute number for the key performance indicator “NPS change” or in percentage value for the key performance indicator “First impressions”). The skilled addressee will appreciate that various alternative embodiments may be provided.

It will be appreciated that data associated with the action campaign may be also provided, which is of great advantage.

For instance, a completion rate and an average score may be provided for each role of the action campaign.

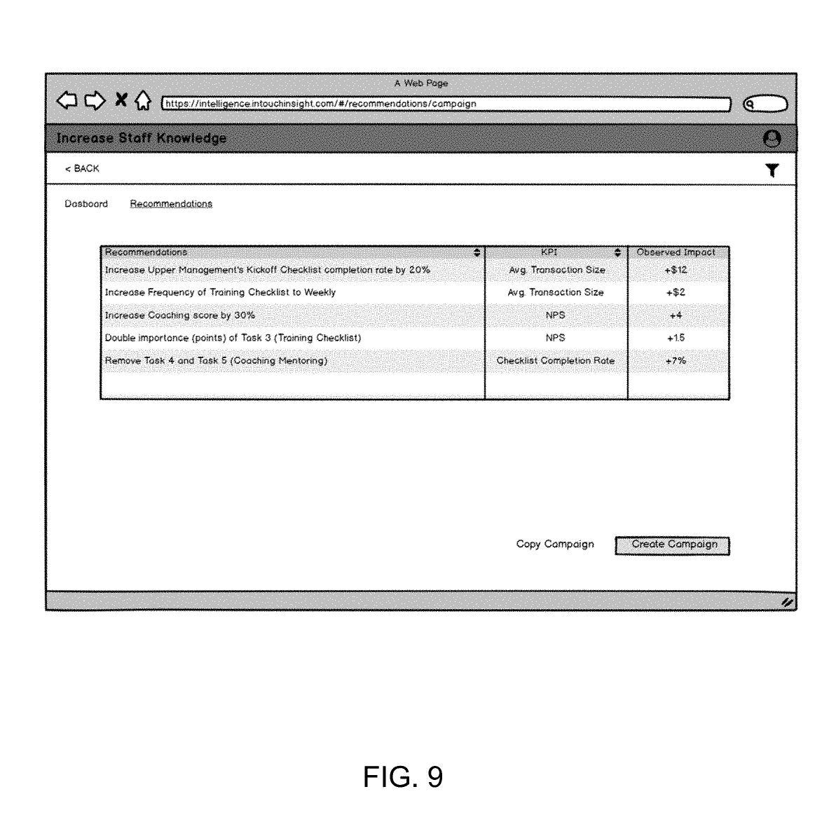

It will be appreciated that the action campaign dashboard may further provide recommendations derived from the action campaign as shown in FIG. 9.

For instance and as disclosed in FIG. 9, five recommendations are disclosed with their corresponding key performance indicator and an observed impact associated with the key performance indicator.

It will be appreciated that the recommendations may be generated using the data collected from the action campaigns performed. Various statistical methods (e.g., multi-variate regression) may be performed on the collected data (observations). Stats methods will determine an impact of one variable (Task 4 on training checklist) on another variable (e.g., key performance indicator (KPI) like NPS). This will drive the recommendations.

It has been contemplated that this may be of great advantage as further explained herein.

It will be appreciated that the recommendations may also be generated using an artificial intelligence module operating using the data collected from the action campaigns performed. The artificial intelligence module may use a machine learning algorithm which is trained over a dataset to predict a given outcome. The dataset may comprise previous collected data. The skilled addressee will appreciate that this may be implemented according to various embodiments.

Now referring back to FIG. 3 and according to processing step 50, the generated action campaign dashboard is provided.

It will be appreciated that the generated action campaign dashboard may be provided according to various embodiments.

In one embodiment, the action campaign dashboard is provided to a user interacting with the processing device 2.

In another embodiment, the action campaign dashboard is provided to a remote processing device, not shown, operatively connected to the processing device 2 via a data network, for instance.

In another alternative embodiment, the action campaign is stored in the memory unit 30 of the processing device 2.

Now referring back to FIG. 2, it will be appreciated that the application for generating an adaptive action campaign involving a plurality of users 34 comprises instructions for generating an action campaign, the action campaign comprising at least one task to be performed by at least one corresponding user, each user located in a corresponding location.

The application for generating an adaptive action campaign involving a plurality of users 34 comprises instructions for transmitting an indication of each of the at least one task to be performed to a processing device of a corresponding user of the at least one corresponding user.

The application for generating an adaptive action campaign involving a plurality of users 34 comprises instructions for obtaining data related to the at least one task to be performed from the user processing device of each of the corresponding users.

The application for generating an adaptive action campaign involving a plurality of users 34 comprises instructions for obtaining key performance indicator data related to each location.

The application for generating an adaptive action campaign involving a plurality of users 34 comprises instructions for generating an action campaign dashboard using the obtained data related to the at least one task to be performed and the obtained key performance indicator data, the action campaign dashboard providing an indication of a completion of each task to be performed and the key performance indicator data.

The application for generating an adaptive action campaign involving a plurality of users 34 comprises instructions for providing the generated action campaign dashboard.

It will be appreciated that there is also disclosed a non-transitory computer readable storage medium for storing computer-executable instructions which, when executed, cause a processing device to perform a method for generating an adaptive action campaign involving a plurality of users, the method comprising generating an action campaign, the action campaign comprising at least one task to be performed by at least one corresponding user, each user located in a corresponding location; transmitting an indication of each of the at least one task to be performed to a user processing device of a corresponding user of the at least one corresponding user; obtaining data related to the at least one task to be performed from the user processing device of each of the corresponding users; obtaining key performance indicator data related to each location; generating an action campaign dashboard using the obtained data related to the at least one task to be performed and the obtained key performance indicator data, the action campaign dashboard providing an indication of a completion of each task to be performed and the key performance indicator data and providing the generated action campaign dashboard.

It will be appreciated that the method disclosed is of great advantage for various reasons.

It will be appreciated that the method disclosed herein enables the coordination of tasks, roles and frequencies within a customer experience management platform.

The method disclosed herein also enables performance tracking of customer experience tasks/activities, i.e., action campaigns, on specified business metrics, which is a great advantage.

The method disclosed herein provides a solution to a technical problem of generating, coordinating and managing an action campaign efficiently. Furthermore, it will be appreciated that the processing device is mandatory for implementing the method disclosed herein. In fact, the use of the processing device enables, for instance, the optimization of tasks, roles and frequency based on its correlation to important business metrics or key performance indicators (KPIs), such as for instance and in one embodiment “Net promoter score (NPS),” “retention rate” and “store sales.”

In fact, being able to obtain key performance indicator data related to each location and use such key performance indicator data when generating the action campaign dashboard and during the action campaign per se enables efficient management of the action campaign. It also enables adapting the action campaign accordingly and is therefore of great advantage. The action campaign becomes flexible since it may be readily amended based on feedback provided by the key performance indicator data, for instance. It will be therefore appreciated that this greatly improves the operating of a system for managing tasks as well as the efficiency of the action campaign per se, which are of great advantage.

The method disclosed herein may further generate recommendations based on observations made during at least one of existing action campaigns and past action campaigns, which is of great advantage.

Another advantage provided by the method disclosed herein is that it improves response time to customer feedback by amending accordingly an action campaign.

Another advantage provided by the method disclosed herein is that it enables organizations to objectively and readily track business outcomes to action campaigns.

Another advantage provided by the method disclosed herein is that it may also provide an indication of optimizations or recommendations which may be required to improve business outcomes.

Although the above description relates to a specific preferred embodiment as presently contemplated by the inventor, it will be understood that the invention in its broad aspect includes functional equivalents of the elements described herein.

1. A method for generating an adaptive action campaign involving a plurality of users, the method comprising:
use of a processing unit for:
generating an action campaign, the action campaign comprising at least one task to be performed by at least one corresponding user, each user located in a corresponding location;
transmitting an indication of each of the at least one task to be performed to a user processing device of a corresponding user of the at least one corresponding user;
obtaining data related to the at least one task to be performed from the user processing device of each of the corresponding users;
obtaining key performance indicator data related to each location;
generating an action campaign dashboard using the obtained data related to the at least one task to be performed and the obtained key performance indicator data, the action campaign dashboard providing an indication of a completion of each task to be performed and the key performance indicator data; and
providing the generated action campaign dashboard.

2. The method as claimed in claim 1, wherein the action campaign comprises a plurality of tasks, wherein the generating of the action campaign comprises grouping more than one task to form a checklist of tasks.

3. The method as claimed in claim 2, wherein the generating of the action campaign further comprises associating a temporal indication to each task of the checklist of tasks formed.

4. The method as claimed in claim 3, wherein the generating of the action campaign further comprises performing a checklist of tasks assignment comprising assigning at least one user to the checklist of tasks formed; wherein the transmitting of each of the at least one task to be performed comprises sending to each user processing device of each user of each of the at least one user assigned to the checklist of tasks an indication of the more than one given corresponding task.

5. The method as claimed in claim 4, further comprising amending the checklist of tasks assignment.

6. The method as claimed in claim 1, wherein the generating of the action campaign comprises applying at least one rule on the at least one task to be performed.

7. The method as claimed in claim 6, wherein the at least one rule is derived from data obtained from at least one previous action campaign performed.

8. The method as claimed in claim 1, wherein the generating of the action campaign comprises generating a recommendation.

9. The method as claimed in claim 1, wherein the at least one task to be performed comprises an action to execute and a temporal indication associated with the at least one task.

10. The method as claimed in claim 9, wherein the temporal indication comprises a duration allocated for completing the at least one task.

11. The method as claimed in claim 9, wherein the temporal indication comprises a frequency for performing the at least one task.

12. The method as claimed in claim 1, wherein the generating of the action campaign comprises associating at least one key performance indicator (KPI) with the action campaign, wherein the at least one key performance indicator associated is affected by the action campaign.

13. The method as claimed in claim 1, wherein the transmitting of the indication of each of the at least one task to be performed comprises executing an application on a corresponding user processing device and downloading the indication of each of the at least one task to be performed in the application.

14. The method as claimed in claim 1, wherein the transmitting of the indication of each of the at least one task to be performed comprises a given user accessing a webserver using a corresponding user processing device.

15. The method as claimed in claim 1, wherein the data related to the task to be completed comprises an indication of a completion of the task.

16. The method as claimed in claim 1, wherein the data related to the task to be completed comprises at least one of a geocoded picture and a note related to the task to be completed.

17. The method as claimed in claim 1, wherein the obtaining of the data related to the task to be performed from the user processing device of each of the corresponding users is performed in response to a request.

18. The method as claimed in claim 1, wherein the key performance indicator data related to each location comprises refers to data dependent on the at least one task to be performed.

19. The method as claimed in claim 1, wherein the key performance indicator data related to each location is obtained from a remote processing unit operatively connected with the processing unit.

20. The method as claimed in claim 1, wherein the key performance indicator data related to each location is obtained from a memory unit operatively connected with the processing unit.

21. The method as claimed in claim 1, wherein the providing of the generated action campaign dashboard comprises at least one of displaying an indication of an evolution of the action campaign and displaying at least one recommendation to a user.

22. The method as claimed in claim 1, wherein the providing of the generated action campaign dashboard comprises displaying a task completion rate and an average score for at least one corresponding user.

23. The method as claimed in claim 22, wherein the displaying of the task completion rate and the average score is performed for a plurality of users, wherein each of the plurality of users is from a given role.

24. The method as claimed in claim 1, wherein the action campaign dashboard is provided to at least one of a user interacting with the processing unit and a remote processing device operatively connected with the processing unit.

25. A processing device comprising:
a central processing unit;
a display device;
a communication port;
a memory unit comprising an application for generating an adaptive action campaign involving a plurality of users, the application comprising:
instructions for generating an action campaign, the action campaign comprising at least one task to be performed by at least one corresponding user, each user located in a corresponding location;
instructions for transmitting an indication of each of the at least one task to be performed to a user processing device of a corresponding user of the at least one corresponding user;
instructions for obtaining data related to the at least one task to be performed from the user processing device of each of the corresponding users;
instructions for obtaining key performance indicator data related to each location;
instructions for generating an action campaign dashboard using the obtained data related to the at least one task to be performed and the obtained key performance indicator data, the action campaign dashboard providing an indication of a completion of each task to be performed and the key performance indicator data; and
instructions for providing the generated action campaign dashboard.

26. A non-transitory computer readable storage medium for storing computer-executable instructions which, when executed, cause a processing device to perform a method for generating an adaptive action campaign involving a plurality of users, the method comprising:
generating an action campaign, the action campaign comprising at least one task to be performed by at least one corresponding user, each user located in a corresponding location;
transmitting an indication of each of the at least one task to be performed to a user processing device of a corresponding user of the at least one corresponding user;
obtaining data related to the at least one task to be performed from the user processing device of each of the corresponding users;
obtaining key performance indicator data related to each location;
generating an action campaign dashboard using the obtained data related to the at least one task to be performed and the obtained key performance indicator data, the action campaign dashboard providing an indication of a completion of each task to be performed and the key performance indicator data; and
providing the generated action campaign dashboard.
